(19) United States
(12) Patent Application Publication
(10) Pub. No.: US 2024/0086795 A1
(43) Pub. Date: Mar. 14, 2024

(54) SYSTEM AND METHOD OF DRIVER MATCHING AND DISPATCH

(71) Applicant: Walmart Apollo, LLC, Bentonville, AR (US)

(72) Inventors: Pratosh Deepak RAJKHOWA, Sunnyvale, CA (US); Sandip MAHANTA, Karnataka (IN); Sneha Narahalli BALASUBRAMANYA, San Jose, CA (US); Deepak Ramesh DESHPANDE, San Jose, CA (US); Ankush PATNI, Bangalore (IN); Sandeep KAUL, Meenakshi Planet City (IN); Gourav SONI, Rajasthan (IN); Minal BAJAJ, Bangalore (IN); Rohit JAIN, Sunnyvale, CA (US); Manish GUPTA, Sunnyvale, CA (US)

(21) Appl. No.: 18/509,729

(22) Filed: Nov. 15, 2023

Related U.S. Application Data
(63) Continuation of application No. 16/397,940, filed on Apr. 29, 2019.

(51) Int. Cl. G06Q 10/0631; B60W 40/09; G06Q 10/0835; G08G 1/00

(52) U.S. Cl. CPC G06Q 10/063112; B60W 40/09; G06Q 10/08355; G08G 1/202

(57) ABSTRACT

A system and method of automated driver selection is disclosed. A plurality of driver profiles and a first order are received. Each of the driver profiles includes at least one driver parameter. The first order includes at least one order parameter. A driver score is calculated for each of the plurality of driver profiles for the first order. The driver score is calculated based on the at least one driver parameter and the at least one order parameter. Each driver profile is ranked based on the calculated driver score and a first delivery assignment request is transmitted to a system associated with a first-ranked driver profile. A response is received to the first delivery assignment request.

### CROSS-REFERENCE TO RELATED APPLICATIONS

This application is a continuation of U.S. patent application Ser. No. 16/397,940, filed Apr. 29, 2019, and entitled “SYSTEM AND METHOD OF DRIVER MATCHING AND DISPATCH,” which is incorporated herein in its entirety by reference.

### TECHNICAL FIELD

This application relates generally to order delivery systems and, more specifically, relates to systems and methods for matching drivers and orders.

### BACKGROUND

Driver matching for deliveries generated by a delivery system, such as a grocery system, requires selection of the “right” driver for an order such that the driver accepts the order and completes the order. Current systems use a broadcast method that provides all potential orders to all potential drivers and allows drivers to select orders on a first come-first serve basis. However, such systems allow a few drivers to monopolize orders and fail to incentivize new or lower volume drivers from participating in the system.

In some instances, multiple delivery systems, such as an independent driver system, a commercial delivery system, and/or other systems may each be used to deliver a subset of orders generated by an automated system. Current systems dispatch orders to all available delivery systems without attempting to match individuals orders to individual delivery systems.

### SUMMARY

In various embodiments, a system is disclosed. The system includes a computing device configured to receive a plurality of driver profiles and a first order. Each of the driver profiles includes at least one driver parameter and the first order includes at least one order parameter. The computing device is further configured to calculate a driver score for each of the plurality of driver profiles for the first order. The driver score is calculated based on the at least one driver parameter and the at least one order parameter. The computing device ranks each driver profile based on the calculated driver score and transmits a first delivery assignment request to a system associated with a first-ranked driver profile. A response to the first delivery assignment request is received by the computing device.

In various embodiments, a non-transitory computer readable medium having instructions stored thereon is disclosed. The instructions, when executed by a processor cause a device to perform operations including receiving a plurality of driver profiles and a first order. Each of the driver profiles includes at least one driver parameter and the first order includes at least one order parameter. A driver score is calculated for each of the plurality of driver profiles for the first order. The driver score is calculated based on the at least one driver parameter and the at least one order parameter. Each driver profile is ranked based on the calculated driver score and a first delivery assignment request is transmitted to a system associated with a first-ranked driver profile. A response to the first delivery assignment request is received.

In various embodiments, a method is disclosed. The method includes a step of receiving a plurality of driver profiles and a first order. Each of the driver profiles includes at least one driver parameter and the first order includes at least one order parameter. A driver score is calculated for each of the plurality of driver profiles for the first order. The driver score is calculated based on the at least one driver parameter and the at least one order parameter. Each driver profile is ranked based on the calculated driver score and a first delivery assignment request is transmitted to a system associated with a first-ranked driver profile. A response to the first delivery assignment request is received.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a block diagram of a computer system, in accordance with some embodiments.

FIG. 2 illustrates a network configured to provide driver selection and assignment for one or more orders, in accordance with some embodiments.

FIG. 3 illustrates a driver selection process, in accordance with some embodiments.

FIG. 4 is a flowchart illustrating a method of driver matching, in accordance with some embodiments.

FIG. 5 is a flowchart illustrating a method of driver matching configured to modify driver ranking based on one or more triggers, in accordance with some embodiments.

### DETAILED DESCRIPTION

The description of the preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship. In the claims, means-plus-function clauses, if used, are intended to cover structures described, suggested, or rendered obvious by the written description or drawings for performing the recited function, including not only structure equivalents but also equivalent structures.

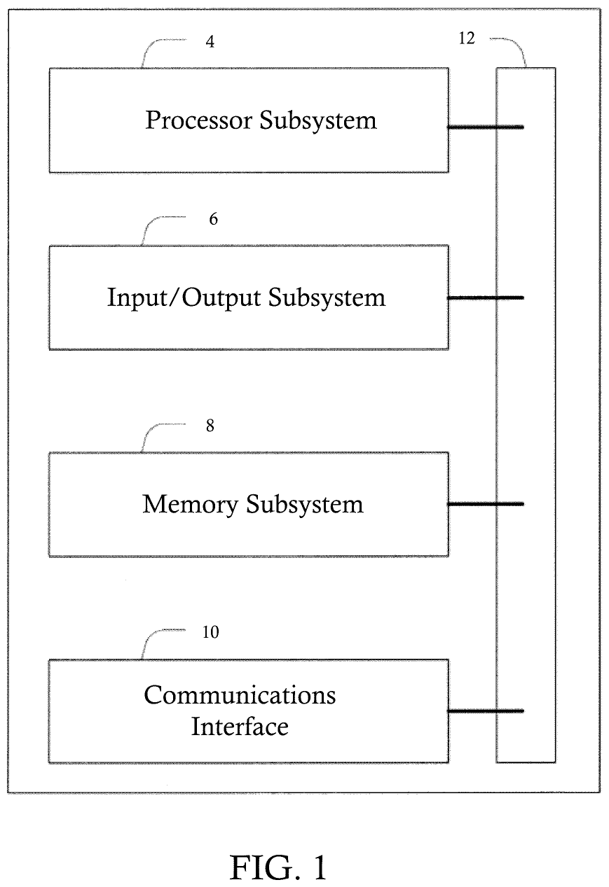

FIG. 1 illustrates a computer system configured to implement one or more processes, in accordance with some embodiments. The system 2 is a representative device and may comprise a processor subsystem 4, an input/output subsystem 6, a memory subsystem 8, a communications interface 10, and a system bus 12. In some embodiments, one or more than one of the system 2 components may be combined or omitted such as, for example, not including an input/output subsystem 6. In some embodiments, the system 2 may comprise other components not combined or comprised in those shown in FIG. 1. For example, the system 2 may also include, for example, a power subsystem. In other embodiments, the system 2 may include several instances of the components shown in FIG. 1. For example, the system 2 may include multiple memory subsystems 8. For the sake of conciseness and clarity, and not limitation, one of each of the components is shown in FIG. 1.

The processor subsystem 4 may include any processing circuitry operative to control the operations and performance of the system 2. In various aspects, the processor subsystem 4 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also may be implemented by a controller, a microcontroller, an application specific integrated circuit (ASIC), a field programmable gate array (FPGA), a programmable logic device (PLD), and so forth.

In various aspects, the processor subsystem 4 may be arranged to run an operating system (OS) and various applications. Examples of an OS comprise, for example, operating systems generally known under the trade name of Apple OS, Microsoft Windows OS, Android OS, Linux OS, and any other proprietary or open source OS. Examples of applications comprise, for example, network applications, local applications, data input/output applications, user interaction applications, etc.

In some embodiments, the system 2 may comprise a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 may include any suitable mechanism or component to enable a user to provide input to system 2 and the system 2 to provide output to the user. For example, the input/output subsystem 6 may include any suitable input mechanism, including but not limited to, a button, keypad, keyboard, click wheel, touch screen, motion sensor, microphone, camera, etc.

In some embodiments, the input/output subsystem 6 may include a visual peripheral output device for providing a display visible to the user. For example, the visual peripheral output device may include a screen such as, for example, a Liquid Crystal Display (LCD) screen. As another example, the visual peripheral output device may include a movable display or projecting system for providing a display of content on a surface remote from the system 2. In some embodiments, the visual peripheral output device can include a coder/decoder, also known as Codecs, to convert digital media data into analog signals. For example, the visual peripheral output device may include video Codecs, audio Codecs, or any other suitable type of Codec.

The visual peripheral output device may include display drivers, circuitry for driving display drivers, or both. The visual peripheral output device may be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 may include any suitable hardware, software, or combination of hardware and software that is capable of coupling the system 2 to one or more networks and/or additional devices. The communications interface 10 may be arranged to operate with any suitable technique for controlling information signals using a desired set of communications protocols, services or operating procedures. The communications interface 10 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 may comprise a wireless interface comprising one or more antennas, transmitters, receivers, transceivers, amplifiers, filters, control logic, and so forth.

In various aspects, the communications interface 10 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 may comprise any machine-readable or computer-readable media capable of storing data, including both volatile/non-volatile memory and removable/non-removable memory. The memory subsystem 8 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the system 2.

In various aspects, the memory subsystem 8 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 may contain an instruction set, in the form of a file for executing various methods, such as methods including A/B testing and cache optimization, as described herein. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor subsystem 4.

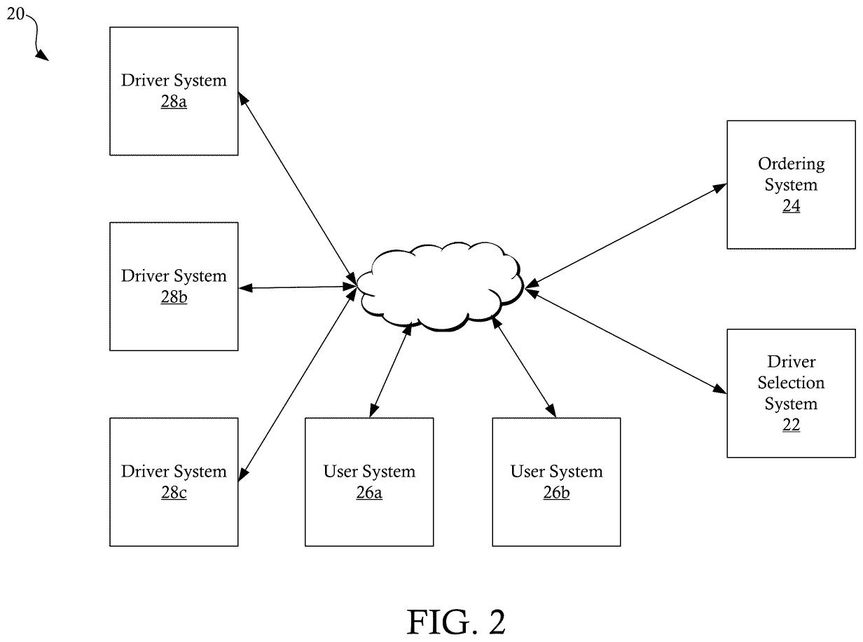

FIG. 2 illustrates a network 20 configured to perform driver matching for one or more received orders, in accordance with some embodiments. In some embodiments, the network 20 includes a driver selection system 22, an ordering system 24, a plurality of user systems 26a-26b, and a plurality of driver systems 28a-28c. Each of the driver selection system 22, the ordering system 24, the user systems 26a-26b, and/or the driver systems 28a-28c comprise a system 2, as described above. Although various embodiments are disclosed herein, it will be appreciated that the systems 22-28c discussed herein can be combined into one or more systems, such as, for example, a single system performing the functions of both a driver selection system 22 and an ordering system 24. It will be appreciated that any number of combinations of systems and/or additional systems may be included in the network 20.

In some embodiments, the ordering system 24 is configured to receive one or more orders. For example, in various embodiments, the ordering system 24 may be configured to receive grocery orders, perishable product orders, service orders, and/or other time-sensitive orders. The ordering system 24 is configured to assign each received order to one of a plurality of delivery slots, such as, for example, hourly slots, multiple hour delivery slots, daily slots, etc. The delivery slots may be specified by the user system 26a-26b when placing the order and/or assigned by the ordering system 24 using one or more assignment processes. After assigning each order to a delivery slot, the ordering system 24 provides the order to a driver selection system 22. The ordering system 24 and/or the driver selection system 22 may be configured to receive and assign orders for a single source location (e.g., a single store, warehouse, distribution center, etc.) and/or a plurality of source locations. In some embodiments, the plurality of source locations may be located in a common geographic area.

In some embodiments, the driver selection system 22 is configured to receive one or more driver profiles associated with one or more drivers. The driver profiles may be generated by individual drivers when signing-up (e.g., onboarding) to be a driver, for example, using a driver system 28a-28c. Driver profiles may include driver-specific parameters or preferences for the associated driver. Driver-specific preferences may include, but are not limited to, delivery location preferences (e.g., radii around one or more source locations), time slot preferences, number of deliveries desired, and/or any other suitable driver-specific preferences. In some embodiments, the driver selection system 22 implements a driver assignment process that generates delivery offers for one or more drivers to deliver one or more orders. Individual drivers, using one or more driver systems 28a-28c, may indicate their acceptance of specific orders.

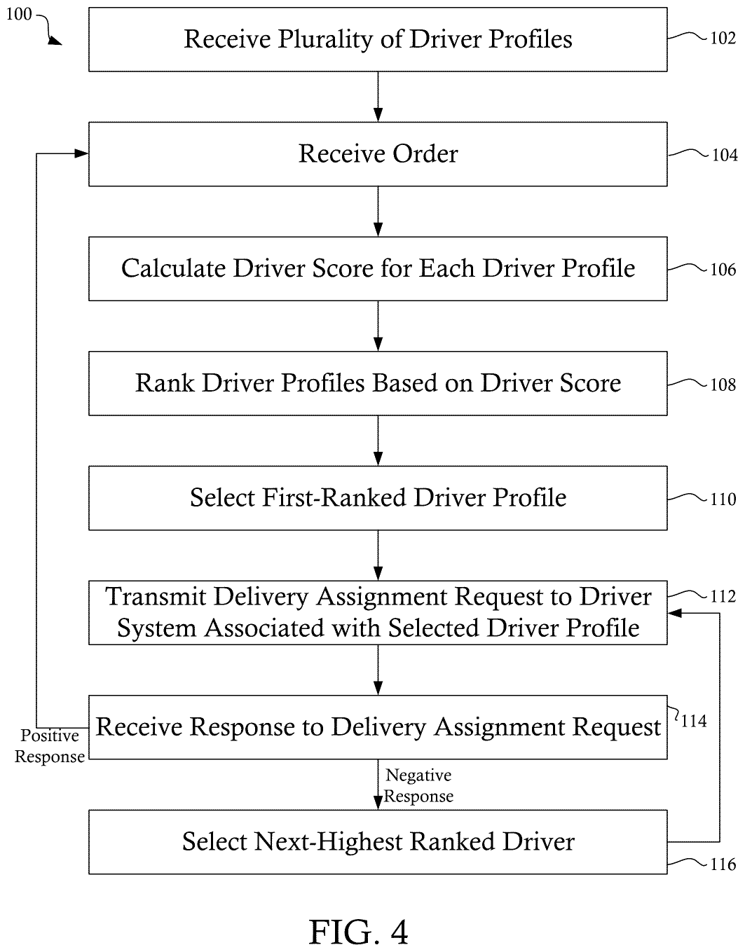

In some embodiments, the driver selection system 22 is configured to implement a driver selection process, as discussed in greater detail below with respect to FIG. 4, to select and assign a driver to each order received from the ordering system 24. The driver selection system 22 can be configured to perform driver selection for each received order on a rolling basis, on a batch basis, and/or using any other suitable processing. In some embodiments, the driver selection system 22 implements a round-robin driver assignment process, as discussed in greater detail below. The driver selection system 22 is configured to rank each driver profile for one or more orders based on system parameters, driver parameters, order parameters etc.

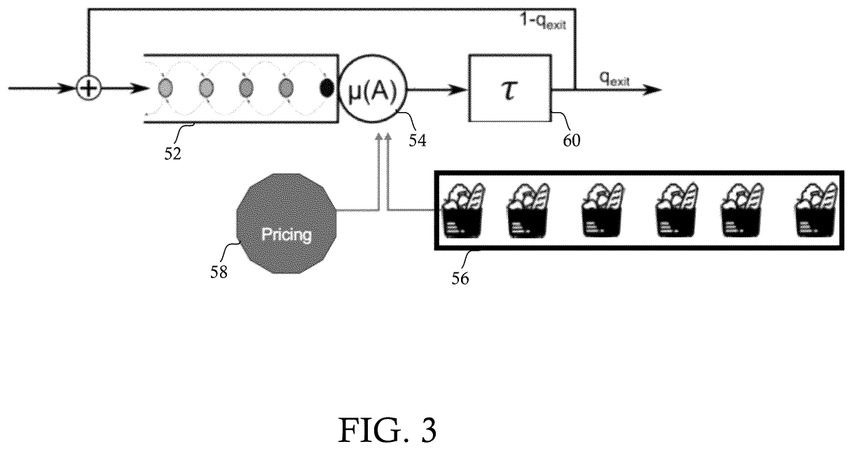

In some embodiments, as illustrated in FIG. 3, the driver selection process implemented by the driver selection system 22, may be represented as a “Jackson Queue” 50. Driver profiles are received by the driver selection system 22 and added to a set of available driver profiles 52. The driver selection system 22 implements a driver selection process 54, such as the driver selection processes 100, 200 discussed in greater detail below. For each order received from the order queue 56, the driver selection process 54 selects a driver from the set of available driver profiles 52 and provides pricing for delivery of the order based on a pricing model 58. When a driver associated with a selected driver profile accepts an assigned order, the driver selection system 22 implements an assignment process 60 to remove the order and the driver profile from the current available queues 52, 56. After performing a delivery, a driver profile may be returned to the set of available driver profiles 52 and/or the driver profile may exit (e.g., the driver is no longer accepting orders).

For example, when receiving an order, the driver selection system 22 may be configured to identify a driver having the “best” profile for the specific order. Drivers may be measured and/or ranked by system-derived statistics (such as acceptance rate, completion rate, delivery time, engagement, etc.), driver provided parameters (e.g., time-slot preferences, source preferences, delivery area preferences, etc.), order parameters (e.g., delivery location, source location, time-slot, order size, etc.) and/or any other suitable criteria. In some embodiments, the driver selection system 22 is configured to group drivers into one or more predetermined groups, such as, for example, based on a level of engagement with the driver selection system 22 (e.g., a first group including drivers who have performed below a first threshold of deliveries, a second group including drivers who have performed between the first threshold and a second threshold of deliveries, a third group including drivers who have performed over the second threshold of deliveries, etc.). In some embodiments, and as discussed in greater detail below, the driver selection system 22 may select drivers based on a percentage split between each group of drivers.

In some embodiments, the driver selection system 22 is configured to generate and/or receive feedback, for example, from one or more user systems 26a, 26b and/or one or more driver systems 28a-28c. In some embodiments, the driver selection system 22 is configured to receive and/or generate feedback including, but not limited to, individual driver acceptance rate, acceptance position (i.e., which driver in a round-robin assignment process accepted an order), and/or any other suitable feedback. In some embodiments, the driver selection system 22 is configured to generate additional feedback and/or statistics, such as, for example, acceptance rate for groups of drivers grouped based on one or more selected criteria.

In some embodiments, the driver selection system 22 implements a round-robin driver selection process configured to select one or more drivers from a group of drivers for one or more orders from a group of orders. The driver selection system 22 is configured to rank each driver profile based on one or more predetermined ranking criteria. In some embodiments, the driver selection system 22 implements a round-robin selection process configured to select a “first-ranked” driver profile and transmit a delivery offer to the selected driver profile. If the “first-ranked” driver does not accept the offer, the round-robin selection process selects a “next-ranked” driver profile and transmits the delivery offer to the selected driver profile.

In some embodiments, the driver selection system 22 is configured to implement group-specific round-robin selection processes configured to select drivers within predetermined segmented groups. For example, in various embodiments, the driver selection system 22 may include a group of preferred drivers, a group of secondary drivers, a group of third-party deliverers, and/or any other suitable group of drivers. The round-robin selection process may be configured to select a first percentage of drivers from a first group, a second percentage of drivers from a second group, a third percentage of drivers from a third group, etc.

In some embodiments, the driver selection system 22 is in signal communication with the one or more driver systems 28a-28c. When the driver selection system 22 selects a driver profile for an order, the driver selection system 22 transmits a delivery request to a driver system 28a-28c associated with the driver profile selected by the driver selection system 22. The driver associated with the driver system 28a-28c may accept the order or may reject the order, either expressly and/or impliedly (e.g., by ignoring a delivery request). If the driver rejects the order, the driver selection system 22 selects a next-ranked driver and transmits the delivery request to the driver system 28a-28c associated with the next-ranked driver. The driver selection system 22 may continue to iterate through the ranked list of driver profiles until a driver accepts the delivery request.

FIG. 4 illustrates a method of round-robin driver matching 100, in accordance with some embodiments. The method 100 is configured to be implemented by one or more systems, such as, for example, the driver selection system 22 discussed above. The method 100 is configured to select a driver for an assigned order using a round-robin process based on one or more driver parameters and/or order parameters, such as, for example, driver availability, driver trips completed, driver rejection preference, order slot, source location, and/or one or more driver/order parameters.

At step 102, the driver selection system 22 receives a plurality of driver profiles each including one or more driver parameters. The driver parameters may include driver parameters or requirements provided by a driver, metrics generated by the driver selection system 22 (such as metrics derived from user feedback, driver feedback, system feedback, aggregation of one or more sets of driver profiles, and/or otherwise provided to the driver selection system 22), and/or any other suitable parameters. For example, the driver parameters may include, but are not limited to, driver availability, driver engagement score (i.e., number of orders delivered over a predetermined time period), slot preferences, non-response rate, rejection rate, total number of deliveries, total number of accepted orders, total number of orders completed once accepted, a starvation score corresponding to a percentage or total number of deliveries over a predetermined time period (such as a day), and/or any other suitable parameters.

In some embodiments, the driver selection system 22 is configured to group sets of drivers into predetermined categories. Example predetermined categories may include, but are not limited to, engaged drivers, non-engaged drivers, high-volume drivers, low-volume drivers, new drivers, veteran drivers, etc. The grouping of drivers may be used by the driver selection system 22 as one parameter during the driver selection process, discussed below. In other embodiments, the driver selection system 22 is configured to provide a first percentage of all orders to a first group of drivers (e.g., engaged drivers), a second percentage of all orders to a second group of drivers (e.g., new drivers), etc. and may provide driver score calculation and/or driver ranking (discussed below) on a per-group basis.

At step 104, the driver selection system 22 receives an order. The order includes one or more order parameters, such as, for example, a pick-up location (e.g., a store, warehouse, etc.), a delivery location, a delivery slot (e.g., a time slot), and/or any other suitable order parameters. The order may be received from an ordering system 24. In some embodiments, the order includes one or more time-sensitive and/or perishable items for delivery.

At step 106, a driver score is calculated for one or more driver profiles maintained by the driver selection system 22. The driver score is calculated based on one or more driver parameters and/or order parameters. The driver score may be order specific (e.g., based on one or more individual order parameters and/or driver parameters) and/or generic (e.g., based on driver parameters and/or common order parameters for a group of orders). For example, in some embodiments, the driver score is calculated by assigning a predetermined weighted value to each of the driver's availability, a slot match between driver slot preferences and the delivery slot, engagement score, non-response rate, rejection rate, source preferences, proximity information (e.g., distance to the source location and/or delivery location), assigned order information (e.g., time slot, location, etc. of other orders assigned to same driver), and/or additional provided and/or derived parameters (e.g., driver parameters, order parameters, system parameters, etc.). In some embodiments, the driver score is calculated using a regression analysis, although it will be appreciated that any suitable method may be used for calculating the driver score from the driver profile parameters and/or order parameters.

In some embodiments, the driver score is calculated based on one or more historic parameters and/or one or more forward-looking parameters. For example, in some embodiments, an initial driver score may be calculated for each driver profile. A first driver profile may be highly-ranked (e.g., 1st, 2nd, etc.) based on historic response and engagement rates. After assigning a predetermined number of orders to the first driver that are not accepted, the driver score for the first driver profile is recalculated using current response and engagement rate variables, which result in the first driver profile being ranked lower due to the driver's current unresponsiveness. When the first driver begins accepting orders, the first driver profile will again return to a highly-ranked position based on both the historical and current response and engagement rates. Although specific embodiments are discussed herein, it will be appreciated that any historic, current, and/or forward-looking parameters may be tracked and used to calculate (or re-calculate) a driver score.

At step 108, the driver profiles are ranked according to the calculated driver score. In some embodiments, the driver score and/or the driver ranking for each driver is at least partially based on a grouping of each driver profile. For example, in some embodiments, the driver selection system 22 is configured to assign a first percentage of received orders to a first group of drivers (e.g., highly-engaged drivers, highly-ranked drivers, high-volume drivers, etc.) and a second percentage of received orders to a second group of drivers (e.g., new drivers, low-engagement drivers, etc.). The driver selection system 22 may include each driver's group in the driver score calculation as a weighted variable to ensure a proper distribution of orders. Alternatively, the driver selection system 22 may rank each group of drivers independently (e.g., first ranking of highly-engaged drivers, second ranking of new drivers, etc.) and select drivers from each ranking to achieve the desired distribution of orders among each group. The desired distribution may be assigned manually and/or generated based on one or more machine learning algorithms. As discussed in greater detail with respect to FIG. 4, the distribution among each group may be adjusted based on user feedback and/or system feedback.

At step 110, the driver selection system 22 selects the highest ranked driver (or lowest ranked driver if lower scores are used to indicate a closer match) and, at step 112, sends a delivery request to the driver system 28a-28c associated with the selected driver. At step 114, the driver selection system 22 receives a response to the delivery assignment request. The response may include a positive response (i.e., acceptance of an order) or a negative response (e.g., rejection of an order, expiration of a predetermined time period, etc.). If the driver selection system 22 receives a positive response to the delivery assignment request, the driver selection system 22 assigns the selected driver to the order and returns to step 104. If the driver selection system 22 receives a negative response to the driver assignment request, the driver selection system 22 proceeds to step 116.

At step 116, the driver selection system 22 selects the next-ranked driver (e.g., second-ranked driver) and, returning to step 112, sends a delivery assignment to the next-ranked driver. At step 114, the driver selection system 22 receives a response from the next-ranked driver. If the next-ranked driver accepts to the delivery assignment, the driver selection system 22 assigns the next highest ranked-driver to the order and returns to step 104. If the next-ranked driver rejects the delivery requests, the driver selection system 22 proceeds to step 116 and again selects a next-ranked driver (e.g., third ranked driver). In some embodiments, the driver selection system 22 will continue to iterate through steps 112-1116 (and through the ranked-list of drivers) until a driver accepts the delivery request.

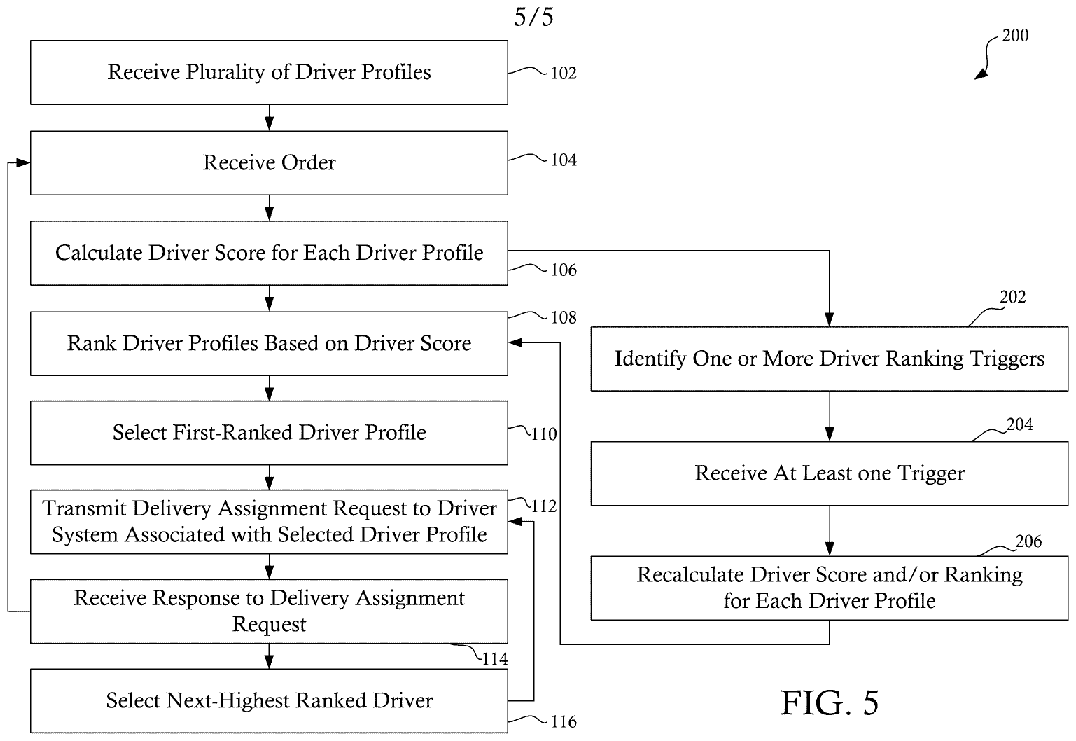

FIG. 5 illustrates a method of driver matching 200 configured to modify driver ranking based on one or more triggers, in accordance with some embodiments. The method 200 is configured to be implemented by one or more systems, such as, for example, the driver selection system 22 discussed above. The method 200 is similar to the method 100 discussed in conjunction with FIG. 4, and similar description is not repeated herein. The method 200 proceeds through steps 102-116 as described above with respect to method 100 but includes additional steps for detecting one or more triggers and modifying driver rankings based on the one or more triggers.

As shown in FIG. 5, method 200 includes steps 202-206 that are executed simultaneously with and/or interleaved with steps 110-116. The illustrated embodiment includes a simultaneous execution path, though it will be appreciated that the order of steps illustrated does not necessarily have to be executed as shown. At step 202, the driver selection system 22 identifies one or more potential triggers for modifying the driver ranking and/or group distribution of orders generated at step 108. Suitable triggers may include, but are not limited to, adjustments to the percentage weighting for different classifications of drivers based on one or more driver parameters, assignment of additional drivers to one or more predetermined categories or rankings, response rates for drivers in one or more predetermined categories, increase or decrease in package/order delivery, and/or any other suitable factors.

At step 204, the driver selection system 22 receives at least one trigger from the set of potential triggers and, at step 206, the driver selection system 22 recalculates the ranking of each driver profile and/or the percentage distribution of orders among groups of drivers. The recalculated rankings may use different weighting for one or more driver parameters. For example, in some embodiments, a recalculated driver ranking may adjust the percentage of orders distributed to high-volume drivers, mid-volume drivers, low-volume drivers, and/or new drivers. It will be appreciated that the driver scores may be recalculated according to any suitable weighting and/or modification to the original score calculation. The method returns to step 108 and uses the new driver scores and/or group distribution for assigning drivers to orders received by the driver selection system 22.

In some embodiments, the method 200 is configured to adjust the driver scores and/or group distribution based on one or more real-time parameters, such as, for example, a rolling response rate, rolling delivery rate, and/or other factors capturing real-time and/or changing parameters. For example, if an initial ranking places a first driver profile above a second driver profile but the second driver has a higher rolling response rate, the driver selection system 22 may adjust the driver score calculation to position the second driver above the first driver profile based on the rolling response rate.

In some embodiments, the distribution and/or ranking of driver profiles is adjusted based on models generated by one or more machine learning processes. For example, in some embodiments, the driver selection system 22 may implement an automated prediction model configured to predict incoming order requirements and rank drivers to provide a best-case solution for the expected deliveries. The automated prediction model may be configured to adjust weightings and/or ranking calculations based on historic, real-time, and/or expected metrics, parameters, and/or other information. The driver selection system 22 may rank driver profiles based on anticipated orders not yet received by the system and/or expected volume requirements to provide an optimal distribution of orders among various drivers.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a communications interface configured to transmit or receive data over one or more communication networks;
memory storing executable instructions;
one or more processors communicatively coupled to a database, the communications interface, and the memory, the one or more processors configured to execute the executable instructions to:
receive, from one or more of a plurality of computing systems, a plurality of driver profiles, wherein each driver profile in the plurality of driver profiles includes:
(i) availability data,
(ii) driver parameter data, and
(iii) historic system-derived statistic data representative of one of a completion rate, a delivery time, or an engagement rate characterizing a level of interaction;
add each driver profile in the plurality of profiles to a first queue of a network queue;
receive, over the one or more communication networks, at least first order data including at least one order parameter, wherein the first order data is added to a second queue of the network queue;
in response to adding an order to the second queue:
assign each of the plurality of driver profiles to one of a plurality of groups;
receive a distribution percentage assigning a predetermined percentage of the one or more orders to each of the plurality of groups;
select a first group from the plurality of groups based on the distribution percentage;
select a next order from the second queue;
in response to selecting the next order from the second queue, rank each driver profile in the first group, wherein the driver profiles are ranked by applying an automated prediction model configured to receive the driver parameter data and the historic system-derived statistic data and generate a historic driver score, wherein the automated prediction model assigns a predetermined weighted value to each parameter represented in the driver parameter data, wherein the historic driver score is calculated and the driver profiles in the first group are ranked after assigning the plurality of driver profiles to one of the plurality of groups, and wherein the ranking is group specific;
select a first-ranked driver profile of the first group from the first queue, wherein the first-ranked driver profile is selected without consideration of position within the first queue;
transmit, over the one or more communication networks and to a first computing device, a first assignment of the next order and a first-ranked driver profile of the first group;
in response to transmitting the first assignment, remove the first-ranked driver profile from the first queue;
in response to receiving features in response to the first assignment, adjust the driver profiles in the first queue based, at least in part, on real-time data collected by the system;
in response to adjusting the driver profiles, calculate an updated driver score for each of the plurality of driver profiles in the first queue;
receive a signal indicative of a trigger for modifying a ranking of the first group;
in response to receiving the signal indicative of the trigger, re-rank, by the automated prediction model, each driver profile of the first group based on the updated driver score,
transmit, over the one or more communication networks, a second assignment request associated with a first re-ranked driver profile in the first group; and
in response to transmitting the second assignment request, remove the first re-ranked driver profile from the first queue without consideration of position within the first queue.

2. The system of claim 1, wherein execution of the executable instructions further causes the one or more processors to:
receive a rejection response to the first assignment;
transmit a next delivery assignment request to one of the plurality of computing systems associated with a next-ranked driver profile; and
receive a response to the next delivery assignment request.

3. The system of claim 2, wherein the rejection response comprises one of a driver rejection or expiration of a predetermined time period.

4. The system of claim 1, wherein the updated driver score is calculated using a predetermined weighted regression analysis.

5. The system of claim 1, wherein the calculating the updated driver score is further based on at least one driver parameter including proximity information, assigned order information, or both proximity information and assigned order information.

6. The system of claim 1, wherein ranking each driver profile is further based on anticipated orders not yet received by the system or expected volume requirements to provide an optimal distribution of orders among one or more drivers of the plurality of drivers.

7. The system of claim 1, wherein the signal indicative of the trigger is indicative of one of an adjustment to the predetermined weighted value of the driver parameter, assignment of one or more additional driver profiles to the first group, the real-time data including features based on the first assignment, or change in order delivery.

8. A non-transitory computer readable medium having instructions stored thereon, wherein the instructions, when executed by a processor cause a device to perform operations comprising:
receiving, from one or more of a plurality of computing systems, a plurality of driver profiles, wherein each driver profile in the plurality of driver profiles includes:
(i) availability data,
(ii) driver parameter data, and
(iii) historic system-derived statistic data representative of one of a completion rate, a delivery time, or an engagement rate characterizing a level of interaction;
adding each driver profile in the plurality of profiles to a first queue of a network queue;
receiving, over one or more communication networks, at least first order data including at least one order parameter, wherein the first order data is added to a second queue of the network queue;
in response to adding an order to the second queue:
assigning each of the plurality of driver profiles to one of a plurality of groups;
receiving a distribution percentage assigning a predetermined percentage of the one or more orders to each of the plurality of groups;
selecting a first group from the plurality of groups based on the distribution percentage;
selecting a next order from the second queue;
in response to selecting the next order from the second queue, ranking each driver profile in the first group, wherein the driver profiles are ranked by applying an automated prediction model configured to receive the driver parameter data and the historic system-derived statistic data and generate a historic driver score, wherein the automated prediction model assigns a predetermined weighted value to each parameter represented in the driver parameter data, wherein the historic driver score is calculated and the driver profiles in the first group are ranked after assigning the plurality of driver profiles to one of the plurality of groups, and wherein the ranking is group specific;
selecting a first-ranked driver profile of the first group from the first queue, wherein the first-ranked driver profile is selected without consideration of position within the first queue;
transmitting, over the one or more communication networks and to a first computing device, a first assignment of the next order and a first-ranked driver profile of the first group;
in response to transmitting the first assignment, removing the first-ranked driver profile from the first queue;
in response to receiving features in response to the first assignment, adjusting the driver profiles in the first queue based, at least in part, on real-time data collected by the system;
in response to adjusting the driver profiles, calculating an updated driver score for each of the plurality of driver profiles in the first queue;
receiving a signal indicative of a trigger for modifying a ranking of the first group;
in response to receiving the signal indicative of the trigger, re-ranking, by the automated prediction model, each driver profile of the first group based on the updated driver score,
transmitting, over the one or more communication networks, a second assignment request associated with a first re-ranked driver profile in the first group; and
in response to transmitting the second assignment request, removing the first re-ranked driver profile from the first queue without consideration of position within the first queue.

9. The non-transitory computer readable medium of claim 8, wherein the instructions further causes the device to perform operations comprising:
receiving a rejection response to the first assignment;
transmitting a next delivery assignment request to one of the plurality of computing systems associated with a next-ranked driver profile; and
receiving a response to the next delivery assignment request.

10. The non-transitory computer readable medium of claim 9, wherein the rejection response comprises one of a driver rejection or expiration of a predetermined time period.

11. The non-transitory computer readable medium of claim 8, wherein the updated driver score is calculated using a predetermined weighted regression analysis.

12. The non-transitory computer readable medium of claim 8, wherein the calculating the updated driver score is further based on at least one driver parameter including proximity information, assigned order information, or both proximity information and assigned order information.

13. The non-transitory computer readable medium of claim 8, wherein ranking each driver profile is further based on anticipated orders not yet received by the system or expected volume requirements to provide an optimal distribution of orders among one or more drivers of the plurality of drivers.

14. The non-transitory computer readable medium of claim 8, wherein the signal indicative of the trigger is indicative of one of an adjustment to the predetermined weighted value of the driver parameter, assignment of one or more additional driver profiles to the first group, the real-time data including features based on the first assignment, or change in order delivery.

15. A computer-implemented method, comprising:
receiving, from one or more of a plurality of computing systems, a plurality of driver profiles, wherein each driver profile in the plurality of driver profiles includes:
(i) availability data,
(ii) driver parameter data, and
(iii) historic system-derived statistic data representative of one of a completion rate, a delivery time, or an engagement rate characterizing a level of interaction;
adding each driver profile in the plurality of profiles to a first queue of a network queue;
receiving, over one or more communication networks, at least first order data including at least one order parameter, wherein the first order data is added to a second queue of the network queue;
in response to adding an order to the second queue:
assigning each of the plurality of driver profiles to one of a plurality of groups;
receiving a distribution percentage configured to assign a predetermined percentage of the one or more orders to each of the plurality of groups;
selecting a first group from the plurality of groups based on the distribution percentage;
selecting a next order from the second queue;
in response to selecting the next order from the second queue, ranking each driver profile in the first group, wherein the driver profiles are ranked by applying an automated prediction model configured to receive the driver parameter data and the historic system-derived statistic data and generate a historic driver score, wherein the automated prediction model is configured to assign a predetermined weighted value to each parameter represented in the driver parameter data, wherein the historic driver score is calculated and the driver profiles in the first group are ranked after assigning the plurality of driver profiles to one of the plurality of groups, and wherein the ranking is group specific;
selecting a first-ranked driver profile of the first group from the first queue, wherein the first-ranked driver profile is selected without consideration of position within the first queue;
transmitting, over the one or more communication networks and to a first computing device, a first assignment of the next order and a first-ranked driver profile of the first group;
in response to transmitting the first assignment, removing the first-ranked driver profile from the first queue;
in response to receiving features in response to the first assignment, adjusting the driver profiles in the first queue based, at least in part, on real-time data collected by the system;
in response to adjusting the driver profiles, calculating an updated driver score for each of the plurality of driver profiles in the first queue;
receiving a signal indicative of a trigger for modifying a ranking of the first group;
in response to receiving the signal indicative of the trigger, re-ranking, by the automated prediction model, each driver profile of the first group based on the updated driver score,
transmitting, over the one or more communication networks, a second assignment request associated with a first re-ranked driver profile in the first group; and
in response to transmitting the second assignment request, removing the first re-ranked driver profile from the first queue without consideration of position within the first queue.

16. The computer-implemented method of claim 15, comprising:
receiving a rejection response to the first assignment, wherein the rejection response comprises one of a driver rejection or expiration of a predetermined time period;
transmitting a next delivery assignment request to one of the plurality of computing systems associated with a next-ranked driver profile; and
receiving a response to the next delivery assignment request.

17. The computer-implemented method of claim 15, wherein the updated driver score is calculated using a predetermined weighted regression analysis.

18. The computer-implemented method of claim 15, wherein the calculating the updated driver score is further based on at least one driver parameter including proximity information, assigned order information, or both proximity information and assigned order information.

19. The computer-implemented method of claim 15, wherein ranking each driver profile is further based on anticipated orders not yet received by the system or expected volume requirements to provide an optimal distribution of orders among one or more drivers of the plurality of drivers.

20. The computer-implemented method of claim 15, wherein the signal indicative of the trigger is indicative of one of an adjustment to the predetermined weighted value of the driver parameter, assignment of one or more additional driver profiles to the first group, the real-time data including features based on the first assignment, or change in order delivery.
